(19) United States
(12) Patent Application Publication
(10) Pub. No.: US 2008/0065441 A1
(43) Pub. Date: Mar. 13, 2008

(54) Bi-directional systematic referral fee share

(75) Inventors: Scott Langmack, Hillsborough, CA (US); Alexander Ovsiankin, Sunnyvale, CA (US); Dave Izuka, San Carlos, CA (US); Chin-Heng Hong, Hillsborough, CA (US); Suzanne Morgan, Greenwood Village, CO (US)

Correspondence Address: CARR & FERRELL LLP, 2200 GENG ROAD, PALO ALTO, CA, 94303, US

(73) Assignee: Blue Chip Expert

(21) Appl. No.: 11/900,690

(22) Filed: Sep. 12, 2007

Related U.S. Application Data
(60) Provisional application No. 60/843,890, filed on Sep. 12, 2006.

(51) Int. Cl. G06Q 10/00

(52) U.S. Cl. 705/7; 705/39

(57) ABSTRACT

A bi-directional systematic referral fee share system provides financial incentives when a candidate is engaged by a hiring company. When the candidate is engaged, the financial incentives are provided to members of a candidate referral fee pool and to members of a hiring manager referral fee pool. The members of the candidate referral fee pool include a first member of the system if the first member invited the candidate, a second member if the second member invited the first member, and a third member if the third member invited the second member. The members of the hiring manager referral fee pool include a fourth member if the fourth member invited the hiring manager, a fifth member if the fifth member invited the fourth member, and a sixth member if the sixth member invited the fifth member. In some instances, only qualified members of the candidate referral fee pool and/or only qualified members of the hiring manager referral fee pool are provided the financial incentive.

### CROSS-REFERENCE TO RELATED APPLICATIONS

This application claims the benefit of U.S. Provisional Patent Application Ser. No. 60/843,890, filed on Sep. 12, 2006, entitled “System and Method for Creating an Efficient Marketplace for Employment, Including Managing Work Assignments, Candidates, Search and Fulfillment Processes,” which is hereby incorporated by reference.

### BACKGROUND

1. Field of the Invention

Embodiments of the present invention relate generally to incentives for matching candidates and hiring companies, and more particularly to providing a financial incentive to members of a bi-directional systematic referral fee share system directed to same.

2. Related Art

Traditionally, companies may use recruiters, staffing firms, agencies, web-based lists and advertising, printed advertising such as newspapers and magazines, and other ways of finding candidates they wish to hire. Despite the many different methods that companies may use, the hiring managers at companies may believe that the traditional methods are not effective, particularly when the hiring manager is seeking a highly-skilled candidate. Highly-skilled candidates, particularly experts in specialized fields, can be difficult for the hiring managers to locate.

Third parties may play a role in matching a candidate with a hiring company. For example, a recruiter may have access to a database of candidates and have relationships with hiring companies. If the recruiter matches a candidate with the hiring company and the candidate is hired, the recruiter may earn a placement fee.

Other third parties, however, such as a person who introduced the candidate to the recruiter and/or introduced the candidate to the hiring manager, do not conventionally receive any financial incentive. Such an incentive, if offered to the other third parties, may facilitate the matching of candidates with hiring managers. There is, therefore, a need for a system and method that may provide an incentive to one or more third parties to facilitate matching candidates with hiring companies.

### SUMMARY

Various embodiments of the invention include a method for determining a placement fee if a hiring company engages a candidate, distributing a first percentage of the placement fee to a candidate referral fee pool, and distributing a second percentage of the placement fee to a hiring manager referral fee pool. The method further includes determining membership of the candidate referral fee pool to be a first member if the first member invited the candidate, a second member if the second member invited the first member, and a third member if the third member invited the second member. The method further includes determining membership of the hiring manager referral fee pool to be a fourth member if the fourth invited the hiring manager, a fifth member if the fifth member invited the fourth member, and a sixth member if the sixth member invited the fifth member. The method further includes allocating the candidate referral fee pool to the members of the candidate referral fee pool, and allocating the hiring manager referral fee pool to the members of the hiring manager referral fee pool.

Embodiments of the system include a placement fee module configured to determine a placement fee if a hiring company engages a candidate, and a candidate referral fee pool module configured to distribute a first percentage of the placement fee to the candidate referral fee pool, determine a membership of the candidate referral fee pool to be a first member if the first member invited the candidate, a second member if the second member invited the first member, and a third member if the third member invited the second member, and further configured to allocate the candidate referral fee pool to the members of the candidate referral fee pool. Embodiments of the system further include a hiring manager referral fee pool module configured to distribute a second percentage of the placement fee to a hiring manager referral fee pool, determine a membership of the hiring manager referral fee pool to be a fourth member if the fourth member invited the hiring manager, a fifth member if the fifth member invited the fourth member, and a sixth member if the sixth member invited the fifth member, and further configured to allocate the hiring manager referral fee pool to the members of the hiring manager referral fee pool.

According to another embodiment, a computer readable storage medium has embodied thereon a program, the program being executable by a processor for performing a method for a bi-directional systematic fee share. The method includes determining a placement fee if a hiring company engages a candidate, distributing a first percentage of the placement fee to a candidate referral fee pool, and distributing a second percentage of the placement fee to a hiring manager referral fee pool. The method further includes determining membership of the candidate referral fee pool to be a first member if the first member invited the candidate, a second member if the second member invited the first member, and a third member if the third member invited the second member. The method further includes determining membership of the hiring manager referral fee pool to be a fourth member if the fourth invited the hiring manager, a fifth member if the fifth member invited the fourth member, and a sixth member if the sixth member invited the fifth member. The method further includes allocating the candidate referral fee pool to the members of the candidate referral fee pool, and allocating the hiring manager referral fee pool to the members of the hiring manager referral fee pool.

### BRIEF DESCRIPTION OF THE DRAWINGS

FIG. 1 is a block diagram illustrating the relationships related to an engagement between a candidate and a hiring manager.

FIG. 2 is a block diagram illustrating the environment for a bi-directional systematic referral fee share system, according to various embodiments.

FIG. 3 is a flow chart of an exemplary method of allocating a financial incentive to members of a candidate referral fee pool and to members of a hiring manager referral fee pool, according to various embodiments.

FIG. 4 is a flowchart illustrating sub-steps of optional step 340 of FIG. 3.

FIG. 5 is a flowchart illustrating sub-steps of optional step 380 of FIG. 3.

### DETAILED DESCRIPTION

A bi-directional systematic referral fee share system provides financial incentives when a hiring company engages a candidate. Members of the system generally fall into one of three categories namely candidates, hiring managers and networkers. Candidates are those individuals available for work assignments with hiring companies represented through hiring managers. Networkers are third parties, for example recruiters, who are neither candidates nor hiring managers.

The system determines a placement fee that is paid by the hiring company when a candidate becomes engaged. A financial incentive in the form of some of the placement fee is then allocated to one or more members to reward the one or more members for inviting, directly or indirectly, the candidate and/or the hiring manager to become members.

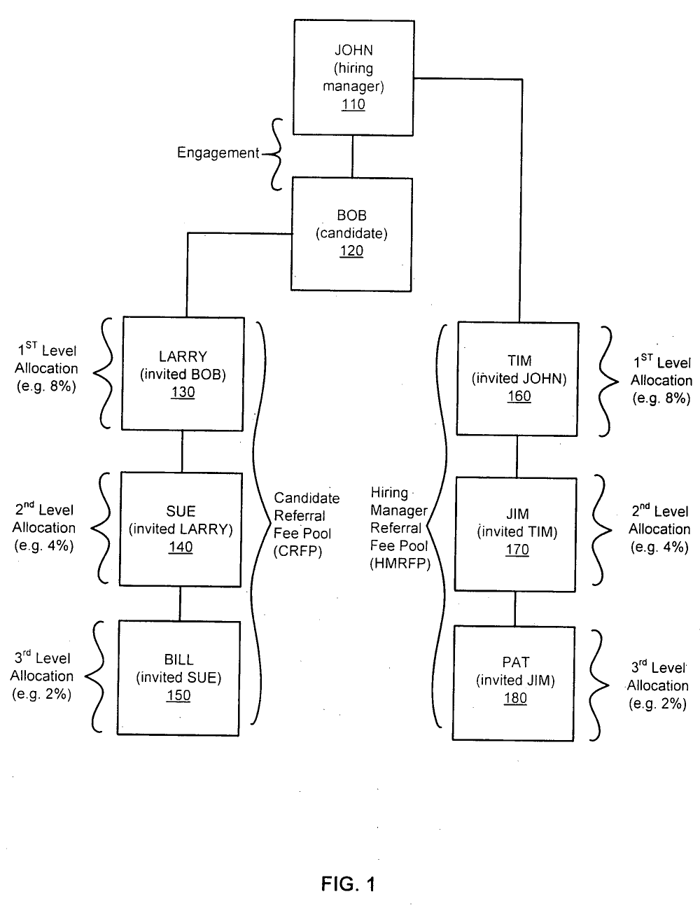

FIG. 1 is a block diagram illustrating the relationships related to an exemplary engagement between a candidate and a hiring manager. FIG. 1 illustrates a number of members and their membership in a candidate referral fee pool (CRFP) and/or a hiring manager referral fee pool (HMRFP) based on their relationship to the candidate and the hiring manager. It is to be understood that the number of members in each of CRFP and HMRFP can be any number and the following discussion of specific numbers of members is merely exemplary.

As shown in this example, John 110 is the hiring manager and Bob 120 is the candidate. Further, in this example, the members of the CRFP are Larry 130 (because Larry invited Bob to be a member), Sue 140 (because Sue invited Larry to be a member), and Bill 150 (because Bill invited Sue to be a member). Similarly, in this example, the members of the HMRFP are Tim 160 (because Tim invited John to be a member), Jim 170 (because Jim invited Tim to be a member) and Pat 180 (because Pat invited Jim to be a member).

Stating this in more general terms, the members of a CRFP include a first member if the first member invited the candidate, a second member if the second member invited the first member, and a third member if the third member invited the second member. Similarly, the members of a HMRFP include a fourth member if the fourth member invited the hiring manager, a fifth member if the fifth member invited the fourth member, and a sixth member if the sixth member invited the fifth member. Thus, in various embodiments, a member may be provided a financial incentive as the result of having invited, directly or indirectly, a candidate or a hiring manager who then participated in an engagement. Again, it is understood that the number of members of a CFRP and the number of members of a HMRFP is not limited to three and can be a greater or lesser number.

In various embodiments, the members of the CRFP may be allocated a financial incentive of some of the placement fee distributed to the CRFP. For example, because Larry 130 invited Bob 120 (the candidate), Larry 130 may be allocated the financial incentive at a first level (e.g., Larry 130 may receive an allocation equal to 8% of the placement fee). Likewise, because Sue 140 invited Larry 130, Sue 140 may be allocated the financial incentive at a second level (e.g., Sue 140 may receive an allocation equal to 4% of the placement fee). Similarly, because Bill 150 invited Sue 140, Bill 150 may be allocated the financial incentive at a third level (e.g., Bill 150 may receive an allocation equal to 2% of the placement fee).

Furthermore, in various embodiments, the members of the HMRFP may be allocated some of the placement fee distributed to the HMRFP For example, because Tim 160 invited John 110 (the hiring manager), Tim 160 may be allocated the financial incentive at a first level (e.g., Tim 160 may receive an allocation equal to 8% of the placement fee). Likewise, because Jim 170 invited Tim 160, Jim 170 may be allocated the financial incentive at a second level (e.g., Jim 170 may receive an allocation equal to 4% of the placement fee). Similarly, because Pat 180 invited Jim 170, Pat 180 may be allocated the financial incentive at a third level (e.g., Pat 180 may receive an allocation equal to 2% of the placement fee).

Although the allocations to the members at a first, second and third level illustrated in FIG. 1 are tiered and shown as 8%, 4% and 2% of a placement fee, respectively, in various embodiments the allocations of a financial inventive may be the same or different percentages of a placement fee, and may be zero percentage of a placement fee in a case where a member fails to have been invited by another member. For example, Sue 140 may not have been invited by a member (i.e., Sue 140 may be self-invited or system-invited rather than having been invited by Bill 150). In this case, Bill 150 would not be included in the CRFP membership and there would be no member at the third level in the CRFP and, therefore, no allocation would be provided at the third level in the CRFP.

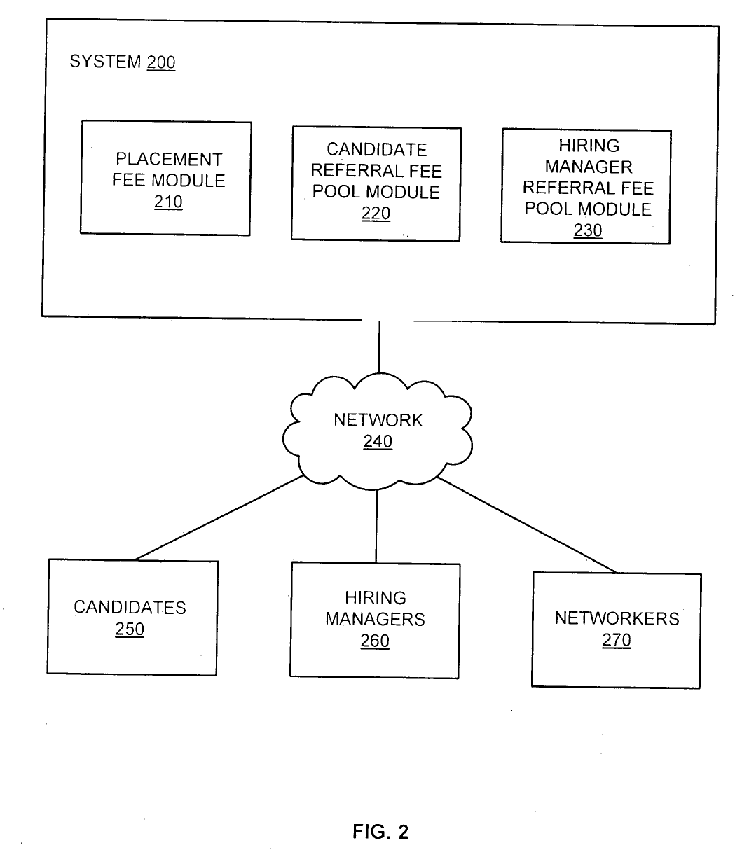

FIG. 2 is a block diagram illustrating the environment for a bi-directional systematic referral fee share system 200, according to various embodiments. System 200 comprises placement fee module 210, candidate referral fee pool module 220, and hiring manager referral fee pool module 230. System 200 communicates through network 240 to candidates 250, hiring managers 260 and networkers 270.

In various embodiments, system 200 may maintain a record of the members. A computer database (not shown) may register and store profiles (e.g., desired job categories, skills, background, work objectives, etc.) from candidates 250, register job requirements from hiring managers 260, and facilitate matching of candidates 250 with hiring managers 260. Members of the system may also include networkers 270 who may be, for example, recruiters, associations, alumni organizations, professional organizations, social networks, etc.

Hiring companies are represented by the hiring managers 260, and the hiring managers 260 may match their job their requirements to the profiles of candidates 250. Job requirements include such information as the background, training and skill level required for a particular job. The matching may be facilitated by a matching engine (not shown), and email messages, web-based links, telephone calls, etc., may be used to connect one of the hiring managers 260 with one of the candidates 250. Hiring managers 260 may use the matching engine to define the requirements for a particular job, and to search a database of profiles of the candidates 250.

When one of the candidates 250 is engaged by a hiring company through one of the hiring managers 260, the placement fee module 210 determines the amount of the placement fee. As used herein, engaged means any paid relationship between a hired candidate and the hiring company including, but not limited to, an employer-employee relationship, a consulting relationship or engagement, a full-time or temporary work assignment, and so on. As such, candidates 250 can be an employee, a consultant, a contractor, etc. The placement fee module 210 may determine the amount of the placement fee in any manner. For example, the placement fee could be determined as a fixed or set fee, or a variable fee, and so on. The amount of the placement fee may also be determined based on, for example, the scarcity of candidates for a particular job, the job requirements, the background and skills of the engaged candidate, the total value of the engagement, the hourly rate of the engaged candidate, geographic location, and so on.

The candidate referral fee pool module 220 determines the members of the CRFP to include a first member of the system if the first member invited the candidate, a second member if the second member invited the first member, and a third member if the third member invited the second member, and further allocates a first percentage of the placement fee to the membership of the CRFP.

The hiring manager referral fee pool module 230 determines the members of the HMRFP to include a fourth member if the fourth member invited the hiring manager, a fifth member if the fifth member invited the fourth member, and a sixth member if the sixth member invited the fifth member, and further allocates a second percentage of the placement fee to the membership of the HMRFP.

In an exemplary embodiment, the system 200 may be implemented using a combination of hardware (not shown) and software (not shown). Examples of hardware may include, but are not limited to, a server (not shown) and/or a processor (not shown), a memory system (not shown), a computer readable storage medium (not shown), and a communication interface (not shown). The server and/or processor may execute the software including an operating system (not shown). The computer readable storage medium may have embodied thereon a program executable by the server and/or processor for performing the bi-directional systematic referral fee share system 200.

The network 240 may be a computer network, such as the Internet or a local area network (LAN) and/or a wide area network (WAN), a wireless network, or a telephone network. Network 240 couples the members to the system 200. Network 240 provides communication between system 200 and computers, telephones, etc., operated by the candidates 250, the hiring managers 260, and the networkers 270.

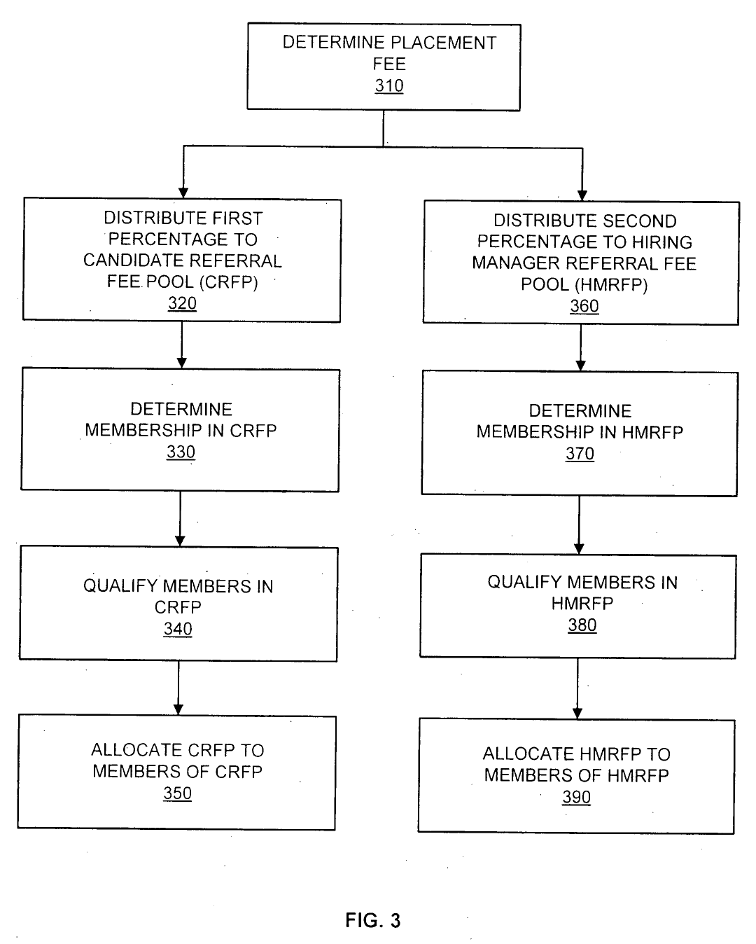

FIG. 3 is a flow chart of an exemplary method of allocating a financial incentive to members of a CRFP and to members of a HMRFP, according to various embodiments. The method includes a determine placement fee step 310, a distribute first percentage to CRFP step 320, a determine membership in CRFP step 330, an optional qualify members in CRFP step 340, an allocate CRFP to members of CRFP step 350, a distribute second percentage to HMRFP step 360, a determine membership in HMRFP step 370, an optional qualify members in HMRFP step 380, and an allocate HMRFP to members of HMRFP step 390.

Reviewing each of these steps in greater detail, in step 310 a placement fee is determined if a hiring company engages a candidate. As discussed further herein, the placement fee may be determined in any manner.

In step 320, a first percentage of the placement fee is distributed to the CRFP. In one embodiment, the first percentage is 14% of the placement fee.

In step 330, the membership of the CRFP is determined to be a first member if the first member invited the candidate, a second member if the second member invited the first member, and a third member if the third member invited the second member.

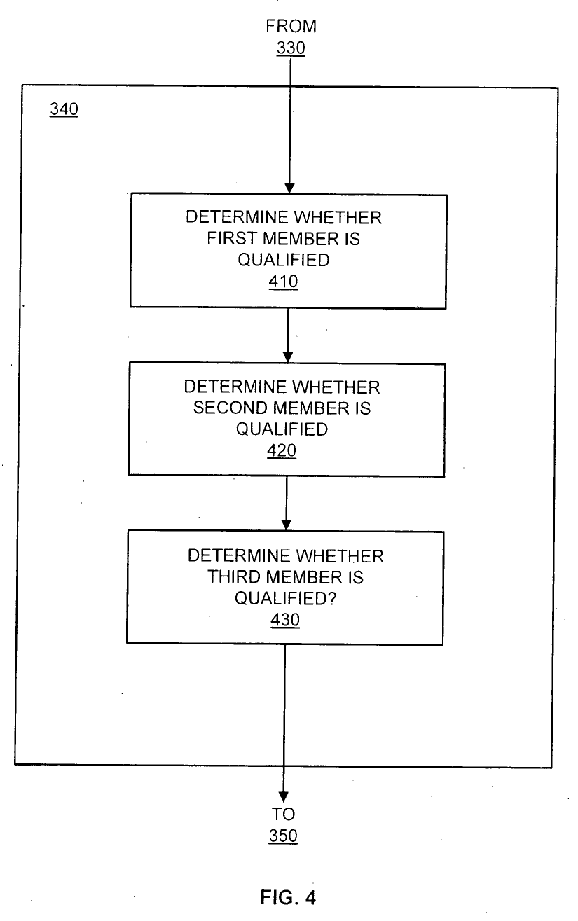

In optional step 340, the members of the CRFP are qualified to be allocated a financial incentive. The qualifications are discussed further herein with respect to FIG. 4.

In step 350, the CRFP is allocated to the members of the CRFP. Step 350 may allocate the CRFP to the members of the CRFP in any manner. For example, the allocation may be a tiered allocation to provide financial incentives to the members of the CRFP. For example, in various embodiments the CRFP may be allocated such that the financial incentive allocated to the first level (i.e., the first member) is greater than or equal to the financial incentive allocated to the second level (i.e., the second member), and the financial incentive allocated to the second level is greater than or equal to the financial incentive allocated to the third level (i.e., the third member). In one example, the member of the CRFP at a first, second and third level may be allocated 8%, 4% and 2% of the placement fee, respectively. If optional step 340 is performed, the allocation in step 350 may be based on qualifications discussed with reference to FIG. 4 such that no allocation is made to a member who is determined to be not qualified.

In step 360, a second percentage of the placement fee is distributed to the HMRFP. In one example, the second percentage is 14% of the placement fee determined at step 310. The second percentage of the placement fee distributed in step 360 may be equal to the first percentage of the placement fee discussed with reference to step 320.

In step 370, the membership of the HMRFP is determined to be a fourth member if the fourth member invited the hiring manager, a fifth member if the fifth member invited the fourth member, and a sixth member if the sixth member invited the fifth member.

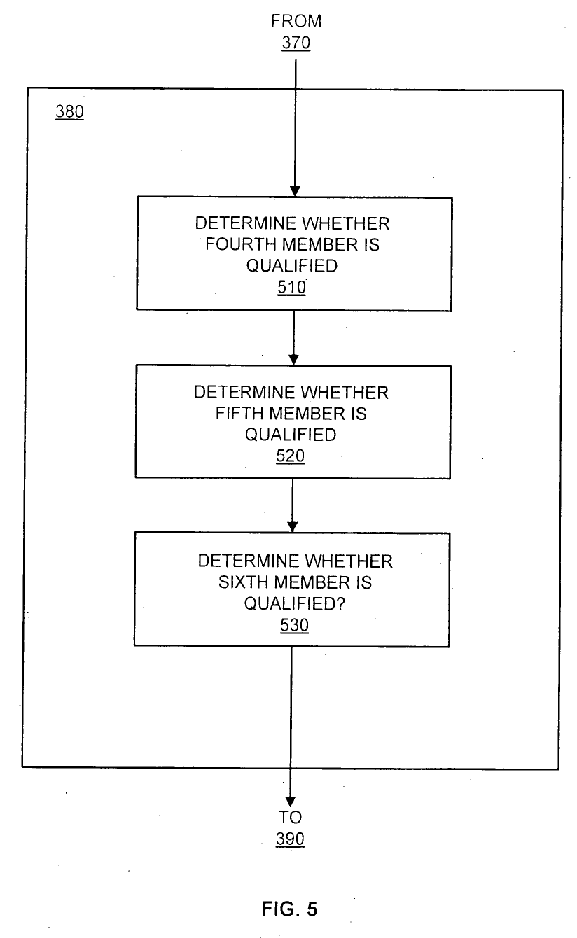

In optional step 380, the members of the HMRFP are qualified to be allocated a financial incentive. The qualifications are discussed further herein with respect to FIG. 5.

In step 390, the HMRFP is allocated to the members of the HMRFP. Step 390 may allocate the HMRFP to the members of the HMRFP in any manner. For example, the allocation may be a tiered allocation to provide financial incentives to the members of the HMRFP. For example, in various embodiments the first percentage of the placement fee may be allocated such that the financial incentive allocated to the first level (i.e., the fourth member) is greater than or equal to the financial incentive allocated to the second level (i.e., the fifth member), and the financial incentive allocated to the second level is greater than or equal to the financial incentive allocated to the third level (i.e., the sixth member). In one example, the member of the HMRFP at the first, second and third level may be allocated 8%, 4% and 2% of a placement fee, respectively. If optional step 380 is performed, the allocation in step 390 may be based on qualifications discussed with reference to FIG. 5, again such that no allocation is made to a member who is determined to be not qualified.

FIG. 4 is a flowchart illustrating sub-steps of optional step 340 of FIG. 3, according to various embodiments. The sub-steps include determining whether first member is qualified step 410, determining whether second member is qualified step 420, and determining whether third member is qualified step 430.

Reviewing each of these steps in greater detail, in step 410, a determination is made whether a first member is qualified to be provided the allocation discussed with reference to step 350 (FIG. 3). If the first member is one of the candidates 250 or one of the hiring managers 260 discussed with reference to FIG. 2, then the determination may be based on any one ore more of the following queries:
a. Did the first member become a member within the past year? If so, the first member is qualified.
b. During the past year, have there been placement fees as a result of the first member being engaged by one or more hiring companies for more than a set number of hours? If so, the first member is qualified.
c. During the past year, have there been placement fees as a result of the first member having engaged one or more candidates for more than a set number of hours? If so, the first member is qualified.
d. Has the first member updated their candidate profile within the last quarter of the year? If so, the first member is qualified.
e. During the past year, have at least a set number of new members become members based on invitations from the first member? If so, the first member is qualified.

If the first member is one of the networkers 270 discussed with reference to FIG. 2, then the determination may be based on any one or more of the following queries:
a. Did the first member become a member within the past year? If so, the first member is qualified.
b. During the past year, have at least a set number of new members become members based on invitations from the first member? If so, the first member is qualified.

It is to be understood that these qualification rules are merely examples and any qualification rules may be used which tend to increase the quantity and/or quality of members in the system and/or facilitate engagements through the system. For example, it may be desirable to formulate qualification rules for a member based on the degree to which candidates and/or hiring managers invited by that member have been active in participating in the engagement process.

At step 420, a determination is made whether a second member is qualified to be provided the allocation discussed with reference to step 350 (FIG. 3). This is essentially the same determination made in step 410 with “first member” replaced by “second member.”

At step 430, a determination is made whether a third member is qualified to be provided the allocation discussed with reference to step 350 (FIG. 3). This is essentially the same determination made in step 410 with “first member” replaced by “third member.”

FIG. 5 is a flowchart illustrating sub-steps of optional step 380 of FIG. 3, according to various embodiments. The sub-steps include determining whether fourth member is qualified step 510, determining whether fifth member is qualified step 520, and determining whether sixth member is qualified step 530.

Reviewing each of these steps in greater detail, in step 510, a determination is made whether a fourth member is qualified to be provided the allocation discussed with reference to step 390 (FIG. 3). This is essentially the same determination made in step 410 (FIG. 4) with “first member” replaced by “fourth member.”

At step 520, a determination is made whether a fifth member is qualified to be provided the allocation discussed with reference to step 390 (FIG. 3). This is essentially the same determination made in step 410 (FIG. 4) with “first member” replaced by “fifth member.”

At step 530, a determination is made whether a sixth member is qualified to be provided the allocation discussed with reference to step 390 (FIG. 3). This is essentially the same determination made in step 410 (FIG. 4) with “first member” replaced by “sixth member.”

Several embodiments are illustrated and/or described herein. However, it will be appreciated that modifications and variations are covered by the above teachings and within the scope of the appended claims without departing from the spirit and intended scope thereof.

The embodiments discussed herein are illustrative of the present invention. As these embodiments are described with reference to illustrations, various modifications or adaptations of the methods or specific elements described may become apparent to those skilled in the art. All such modifications, adaptations, or variations that rely on the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method comprising:
determining a placement fee if a hiring company engages a candidate;
distributing a first percentage of the placement fee to a candidate referral fee pool;
distributing a second percentage of the placement fee to a hiring manager referral fee pool;
determining membership of the candidate referral fee pool to be a first member if the first member invited the candidate, a second member if the second member invited the first member, and a third member if the third member invited the second member;
determining membership of the hiring manager referral fee pool to be a fourth member if the fourth invited the hiring manager, a fifth member if the fifth member invited the fourth member, and a sixth member if the sixth member invited the fifth member;
allocating the candidate referral fee pool to the members of the candidate referral fee pool; and
allocating the hiring manager referral fee pool to the members of the hiring manager referral fee pool.

2. The method of claim 1, wherein the first percentage of the placement fee and the second percentage of the placement fee are equal.

3. The method of claim 2, wherein the first percentage of the placement fee is 14% and the second percentage of the placement fee is 14%.

4. The method of claim 1, wherein the step of allocating the candidate referral fee pool to the members of the candidate referral fee pool includes allocating a financial incentive to the first member, allocating a financial incentive to the second member and allocating a financial incentive to the third member such that the financial incentive allocated to the first member is greater than the financial incentive allocated to the second member and the financial incentive allocated to the second member is greater than the financial incentive allocated to the third member.

5. The method of claim 1, wherein the step of allocating the hiring manager referral fee pool to the members of the hiring manager referral fee pool includes allocating a financial incentive to the fourth member, allocating a financial incentive to the fifth member and allocating a financial incentive to the sixth member such that the financial incentive allocated to the fourth member is greater than the financial incentive allocated to the fifth member and the financial incentive allocated to the fifth member is greater than the financial incentive allocated to the sixth member.

6. The method of claim 1, further comprising:
determining if the first member is qualified;
determining if the second member is qualified;
determining if the third member is qualified;
determining if the fourth member is qualified;
determining if the fifth member is qualified; and
determining if the sixth member is qualified.

7. The method of claim 6, wherein the step of allocating the candidate referral fee pool to the members of the candidate referral fee pool and the step of allocating the hiring manager referral fee pool to the members of the hiring manager referral fee pool comprises:
allocating to the first member an amount equal to 8% of the placement fee if the first member is qualified;
allocating to the second member an amount equal to 4% of the placement fee if the second member is qualified;
allocating to the third member an amount equal to 2% of the placement fee if the third member is qualified;
allocating to the fourth member an amount equal to 8% of the placement fee if the fourth member is qualified;
allocating to the fifth member an amount equal to 4% of the placement fee if the fifth member is qualified; and
allocating to the sixth member an amount equal to 2% of the placement fee if the sixth member is qualified.

8. A system comprising:
a placement fee module configured to determine a placement fee if a hiring company engages a candidate;
a candidate referral fee pool module configured to distribute a first percentage of the placement fee to the candidate referral fee pool, determine a membership of the candidate referral fee pool to be a first member if the first member invited the candidate, a second member if the second member invited the first member, and a third member if the third member invited the second member, and further configured to allocate the candidate referral fee pool to the members of the candidate referral fee pool; and
a hiring manager referral fee pool module configured to distribute a second percentage of the placement fee to a hiring manager referral fee pool, determine a membership of the hiring manager referral fee pool to be a fourth member if the fourth member invited the hiring manager, a fifth member if the fifth member invited the fourth member, and a sixth member if the sixth member invited the fifth member, and further configured to allocate the hiring manager referral fee pool to the members of the hiring manager referral fee pool.

9. The system of claim 8, wherein the first percentage and the second percentage are equal.

10. The system of claim 9, wherein the first percentage is 14% and the second percentage is 14%.

11. The system of claim 8, wherein the candidate referral fee pool module configured to allocate the candidate referral fee pool to the members of the candidate referral fee pool is configured to allocate:
an amount equal to 8% of the placement fee to the first member if the first member is qualified;
an amount equal to 4% of the placement fee to the second member if the second member is qualified; and
an amount equal to 2% of the placement fee to the third member if the third member is qualified.

12. The system of claim 8, wherein the hiring manager referral fee pool module configured to allocate the hiring manager referral fee pool to the members of the hiring manager referral fee pool is configured to allocate:
an amount equal to 8% of the placement fee to the fourth member if the fourth member is qualified;
an amount equal to 4% of the placement fee to the fifth member if the fifth member is qualified; and
an amount equal to 2% of the placement fee to the sixth member if the sixth member is qualified.

13. A computer readable storage medium having embodied thereon a program, the program being executable by a processor for performing a method for a bi-directional systematic fee share, the method comprising:
determining a placement fee if a hiring company engages a candidate;
distributing a first percentage of the placement fee to a candidate referral fee pool;
distributing a second percentage of the placement fee to a hiring manager referral fee pool;
determining membership of the candidate referral fee pool to be a first member if the first member invited the candidate, a second member if the second member invited the first member, and a third member if the third member invited the second member;
determining membership of the hiring manager referral fee pool to be a fourth member if the fourth member invited the hiring manager, a fifth member if the fifth member invited the fourth member, and a sixth member if the sixth member invited the fifth member;
allocating the candidate referral fee pool to the members of the candidate referral fee pool; and
allocating the hiring manager referral fee pool to the members of the hiring manager referral fee pool.

14. The computer readable medium of claim 13, wherein the first percentage and the second percentage are equal.

15. The computer readable medium of claim 13, wherein the first percentage is 14% and the second percentage is 14%.

16. The computer readable medium of claim 13, wherein allocating the candidate referral fee pool to the members of the candidate referral fee pool includes allocating:
an amount equal to 8% of the placement fee to the first member if the first member is qualified;
an amount equal to 4% of the placement fee to the second member if the second member is qualified; and
an amount equal to 2% of the placement fee to the third member if the third member is qualified.

17. The computer readable medium of claim 13, wherein allocating the hiring manager referral fee pool to the members of the hiring manager referral fee pool includes allocating:
an amount equal to 8% of the placement fee to the fourth member if the fourth member is qualified;
an amount equal to 4% of the placement fee to the fifth member if the fifth member is qualified; and
an amount equal to 2% of the placement fee to the sixth member if the sixth member is qualified.

18. A method comprising:
determining a placement fee if a hiring company engages a candidate;
distributing a first percentage of the placement fee to a candidate referral fee pool;
distributing a second percentage of the placement fee to a hiring manager referral fee pool;
determining membership of the candidate referral fee pool to be a first member if the first member invited the candidate and a second member if the second member invited the first member;
determining membership of the hiring manager referral fee pool to be a third member if the third invited the hiring manager and a fourth member if the fourth member invited the third member;
allocating the candidate referral fee pool to the members of the candidate referral fee pool; and
allocating the hiring manager referral fee pool to the members of the hiring manager referral fee pool.

19. A system comprising:
a placement fee module configured to determine a placement fee if a hiring company engages a candidate;
a candidate referral fee pool module configured to distribute a first percentage of the placement fee to the candidate referral fee pool, determine a membership of the candidate referral fee pool to be a first member if the first member invited the candidate and a second member if the second member invited the first member, and further configured to allocate the candidate referral fee pool to the members of the candidate referral fee pool; and
a hiring manager referral fee pool module configured to distribute a second percentage of the placement fee to a hiring manager referral fee pool, determine a membership of the hiring manager referral fee pool to be a third member if the third member invited the hiring manager and a fourth member if the fourth member invited the third member, and further configured to allocate the hiring manager referral fee pool to the members of the hiring manager referral fee pool.
